(19) United States
(12) Patent Application Publication
(10) Pub. No.: US 2011/0272999 A1
(43) Pub. Date: Nov. 10, 2011

(54) WHEEL

(76) Inventor: Simone Roncali, Cartura (IT)

(21) Appl. No.: 12/998,657

(22) PCT Filed: Nov. 16, 2009
(86) PCT No.: PCT/EP2009/065245

§ 371 Date: Jul. 22, 2011

(30) Foreign Application Priority Data
Nov. 18, 2008 (IT) TV2008A000147

(51) Int. Cl. B60B 21/06; B60B 1/04; B60B 5/02; B60B 21/02

(52) U.S. Cl. 301/57

(57) ABSTRACT

A wheel, particularly for cycles or motorcycles, which comprises a rim which has, in transverse cross-section, a polygonal shape, preferably a V-shape. The rim has, at the internal region, an insert or guide which is arc-like, for the resting and sliding of a complementarily shaped end of a spoke which is shaped like an open loop. The ends of the spoke can be inserted at appropriately provided openings formed in the rim in a region that is adjacent to the arc-like guide or insert.

### BACKGROUND OF THE INVENTION

Currently it is known to provide wheels for cycles which are constituted substantially by a rim, with which a tire or inner tube is associated and which is connected to a hub by means of adapted spokes.

Currently it is known to provide bicycle wheels in which, in order to reduce the overall weight of the wheel and therefore have a total mass that is lighter and has better aerodynamics, the number of spokes is reduced.

A first consequence of this choice entails the need to impose very high tensions on the spokes, in order to make the wheel more rigid, but this entails possible breakage of the rim.

Moreover, the use of wheels with a reduced number of spokes has been found to entail an increase in the vibrations of the wheel, due to the alternating arrangement of the spokes with respect to the frame, which due to the tension to which they are subjected entails continuous and alternating oscillations with respect to the plane of arrangement of the rim.

An important technical problem is further constituted by the fact that if one spoke breaks during cycling activity, the wheel inevitably wobbles due to the traction load, which is no longer compensated, of the spoke or spokes that are adjacent to the broken one, and this wobbling makes the wheel touch for example the rear triangle or the brake pads, with consequent immediate locking of the wheel itself and therefore danger for the stability of the cyclist.

An example of the background art is constituted by U.S. Pat. No. 6,231,128 B1; which discloses a bicycle wheel which comprises an annular rim, which has a V-shaped cross-section with a rounded vertex and on the sides of which, approximately in a central region located between said vertex and a resting base for a tubular tire, there are two openings, which have approximately the same axis and through which it is possible to arrange the head of a spoke which is formed monolithically and whose ends are crossed and coupled for example at the hub.

In this solution, which uses an adhesive that is adapted to make the interconnection of the spoke at the openings provided in the rim safer, together with other provided means for locking the spoke to the rim, the same drawbacks noted earlier are observed, in particular the drawback of the imbalance of the wheel in case of breakage of one of the rods that constitute the spoke, with consequent locking of the wheel.

A further drawback that can be observed in this background art is that since the openings for the passage of the spoke are provided at the sides of the rim, such spokes can interfere with the brakes of the bicycle, both in case of breakage of a single rod that constitutes the spoke and in case of displacement of the brake pad, for example due to loosening of the fixing screw.

Another drawback that is observed in this known background art is that the intense traction imposed on the spoke and the particular arrangement of the openings obtained from the rim make said rim form, at such openings, rupture/cracking regions which make the wheel unusable due to loss of uniformity of the load to which the rim is subjected.

U.S. Pat. No. 6,428,113 B2 is also known which discloses a bicycle wheel with tensioned spokes which comprises a rim which has, in cross-section, a substantially V-shaped configuration with a rounded vertex and is provided internally with strengthening flanges; on the surface where the tire or inner tube rests on the rim, as well as on the flanges and on the lateral surfaces for connection to the vertex, there are, along the same axis, holes for the positioning and subsequent tightening of the ends of two distinct spokes.

Even this solution has the drawbacks noted earlier in case of breakage of a single spoke, and further the rim is heavier and therefore the overall weight of the wheel is increased, with a consequent increase in inertia during acceleration and of the energy required along uphill paths.

This prior art also illustrates, in FIG. 20, a solution that provides holes in the rim at the vertex and arranges internally a flange with a flat surface that is directed toward the resting surfaces of the tubular tire; such flat surface constitutes the resting base for the coupling arranged at one end of a single spoke, which can thus be tensioned.

However, even this solution has the drawbacks noted earlier regarding the wobbling of the wheel in case of breakage of each individual spoke.

### SUMMARY OF THE INVENTION

The aim of the present invention is to eliminate the drawbacks noted above, by providing a wheel, particularly for cycles or motorcycles, which in case of breakage of a spoke prevents any lateral wobble of the wheel indicated in the cited background art, thus allowing to continue the race.

Within this aim, an object of the invention is to propose a wheel whose spokes can be associated with the rim rapidly and easily, avoiding inelastic deformations, so as to extend its life cycle.

Another object is to provide a wheel in which the sides of the rim are not subjected to high loads, so as to limit the possibility of fatigue/breakage of the rim.

Another object is to provide a wheel in which the placement of the spokes does not interfere with the brake pads during normal sports practice, if a spoke breaks and in case of unintentional displacement of the brake pads, for example due to loosening of the fixing screw.

Another object is to provide a wheel in which it is possible to achieve optimum transmission of torque from the hub to the rim.

Another object is to obtain a wheel that is easy to assemble and center.

This aim, as well as these and other objects that will become better apparent hereinafter, are achieved by a wheel, particularly for cycles or motorcycles, which comprises a rim which has, in transverse cross-section, a polygonal shape, characterized in that it has, at the internal region, an insert or guide which is arc-like, for the resting and sliding of a complementarily shaped end of a spoke which is shaped like an open loop and can be inserted at appropriately provided openings formed in said rim in a region that is adjacent to said arc-like guide or insert.

### BRIEF DESCRIPTION OF THE DRAWINGS

Further characteristics and advantages of the present invention will become better apparent from the following detailed description of a preferred but not exclusive embodiment of a wheel, particularly for cycles or motorcycles, according to the invention, illustrated by way of non-limiting example in the accompanying drawings, wherein:

FIG. 1 is a partially sectional side view of a rim of a bicycle with the spoke associated therewith, which in turn is interconnected with the hub of a rear wheel;

FIG. 2 is a view, similar to the preceding one, of the interconnection of the spoke with a front wheel;

FIG. 3 is a front or rear view of a single spoke;

FIG. 4 is a top view of the spoke according to FIG. 3;

FIG. 5 is a side view of the spoke;

FIG. 6 is a view of a detail of the interconnection of the spoke with the rim;

FIG. 7 is a view, similar to the preceding one, of a further embodiment of the rim;

FIG. 8 is a view, similar to the view of FIG. 1, of the use of an asymmetric rim;

FIGS. 9 and 10 are views, similar to the views of FIGS. 6 and 7, of the use of an asymmetric rim;

FIG. 11 is a sectional view of the rim in a symmetrical version;

FIG. 12 is a view, similar to the preceding one, of the asymmetric rim;

FIGS. 13, 14 and 15 are top views of some of the possible arrangements of the spoke;

FIGS. 16 to 25 are views of the steps for coupling a single spoke to the rim;

FIGS. 26 to 32 are views of further forms of the rim with the insert or guide inside it.

### DESCRIPTION OF THE PREFERRED EMBODIMENTS

With reference to the figures, a wheel, particularly usable for cycles and for motorcycles, comprises a rim 1, which has, in a transverse cross-section, a polygonal shape, preferably a V-shape, which has a rounded vertex 2 which is blended at the sides 3a, 3b to a supporting base 4 for a tire or inner tube, which is not shown.

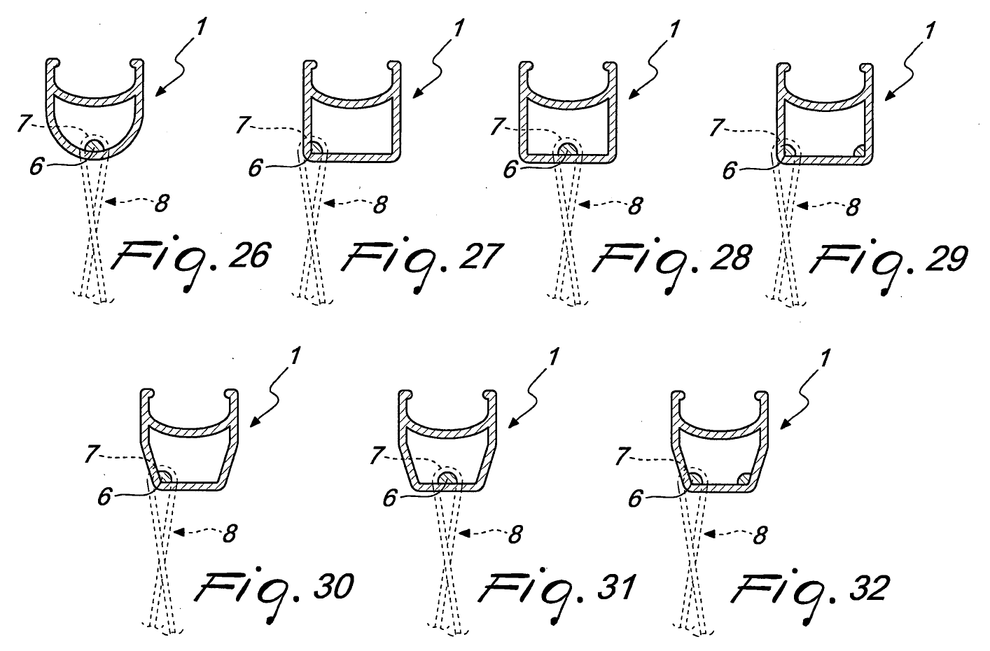

The sectional shape of the rim 1 can also be square or rectangular or U-shaped or pentagonal, as shown in FIGS. 26 to 32.

At an internal region 5 of the vertex 2 there is, inside the rim 1, an insert or guide 6 which has, in the direction of the overlying base 4, an arc-like shape for the resting and sliding of a complementarily shaped end 7 of a spoke 8.

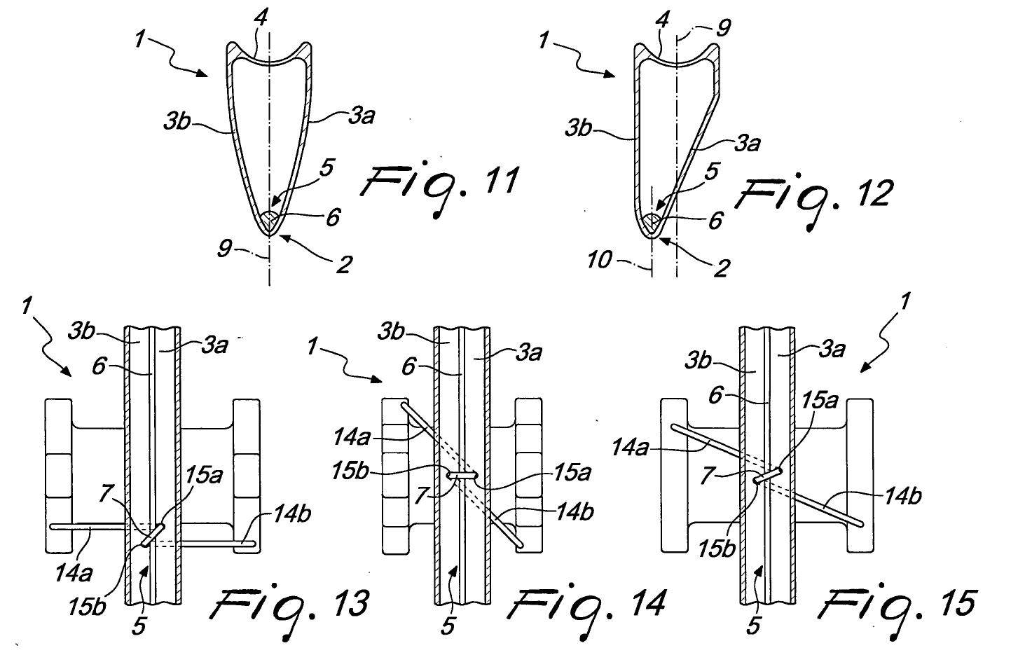

In FIGS. 11 and 12, the insert or guide 6 can be constituted by an element that is applied or obtained during the provision of the rim 1, as shown for example in FIGS. 6 and 7.

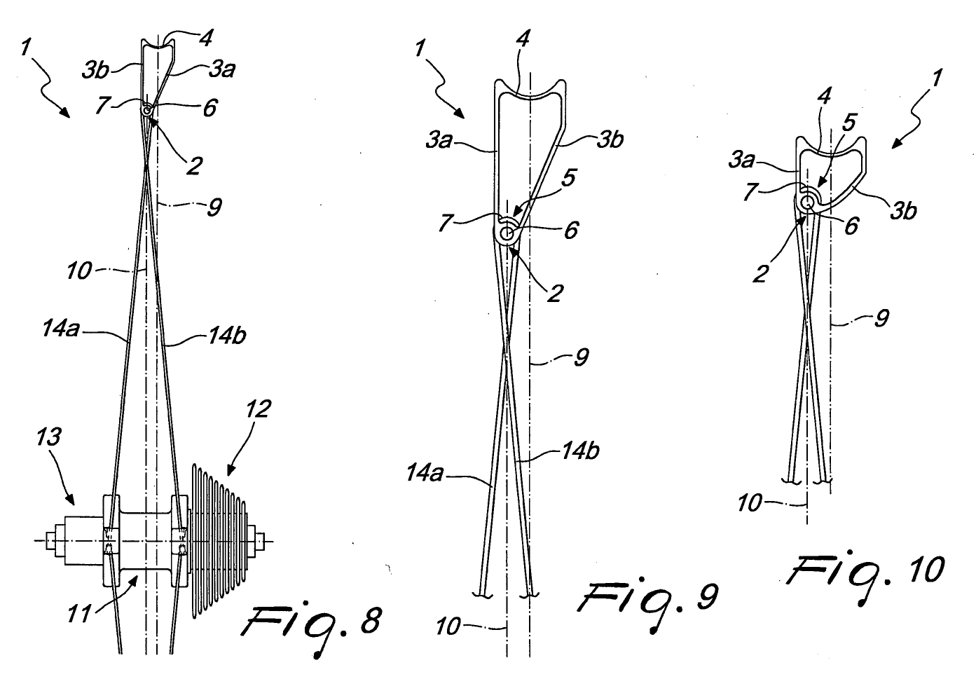

The transverse sectional shape of the rim 1 can be of a type which is mirror-symmetrical with respect to a midplane of the base 4 or can be of the asymmetric type, as shown for example in FIGS. 8, 9, 10 and 12, in which the vertex 2 lies on a plane 10 which is parallel and therefore spaced with respect to the midplane 9 of the base 4.

In this last case, one side of the rim 1, for example the side 3b that is directed, relative to a hub 11, on the opposite side with respect to gears 12, is substantially parallel to the midplane 9.

In this case, as shown in FIG. 8, the plane 10 corresponds to the midplane of the hub 11.

In this solution, the camber of the rear wheel is improved, and it is thus possible to avoid increasing the traction force of the spokes and to move outward a flange 13 that lies opposite the one provided with the gears 12, while maintaining a substantial balance of the tensions between the right side and the left side.

This solution is an improvement with respect to the background art, in which an attempt has been made for example to compensate the asymmetry on the distribution of the spokes by increasing the ones on the side of the freewheel, but this solution increases the operations on the rim, the number of spokes and consequently the likelihood that the breakage of one of the spokes will lead to locking of the wheel.

The spoke 8 is constituted by a single wire, which is bent approximately halfway along its length so as to define the arc-like end 7, which is shaped so as to be able to rest and slide at the insert or guide 6 that is present within the rim 1.

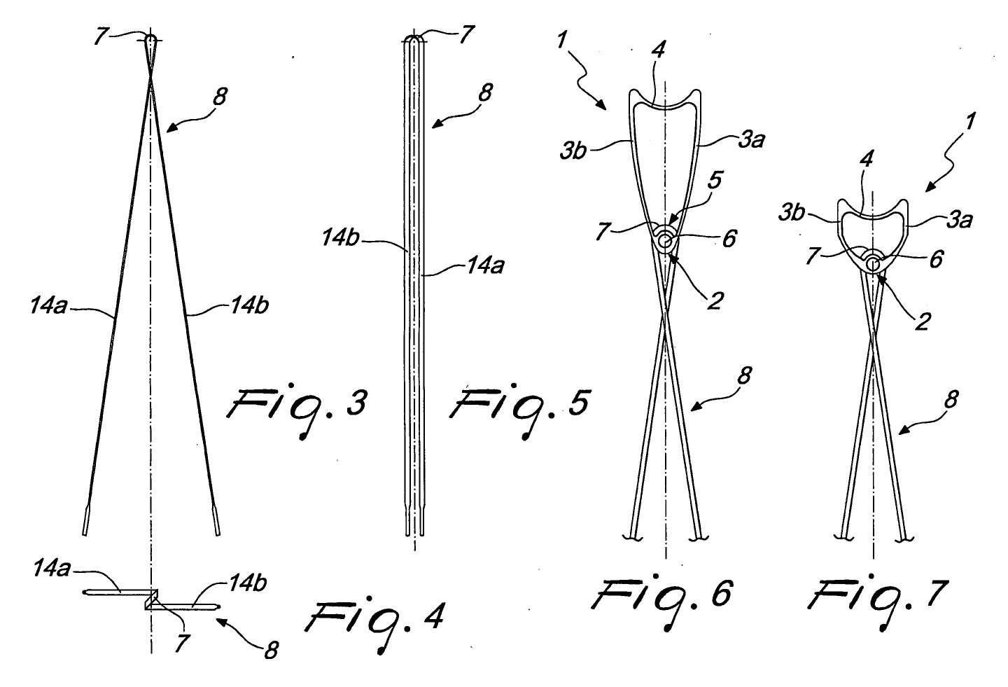

The spoke 8 can be of the type shown for example in FIG. 3, in which arms 14a, 14b are defined which are mutually crossed or straight.

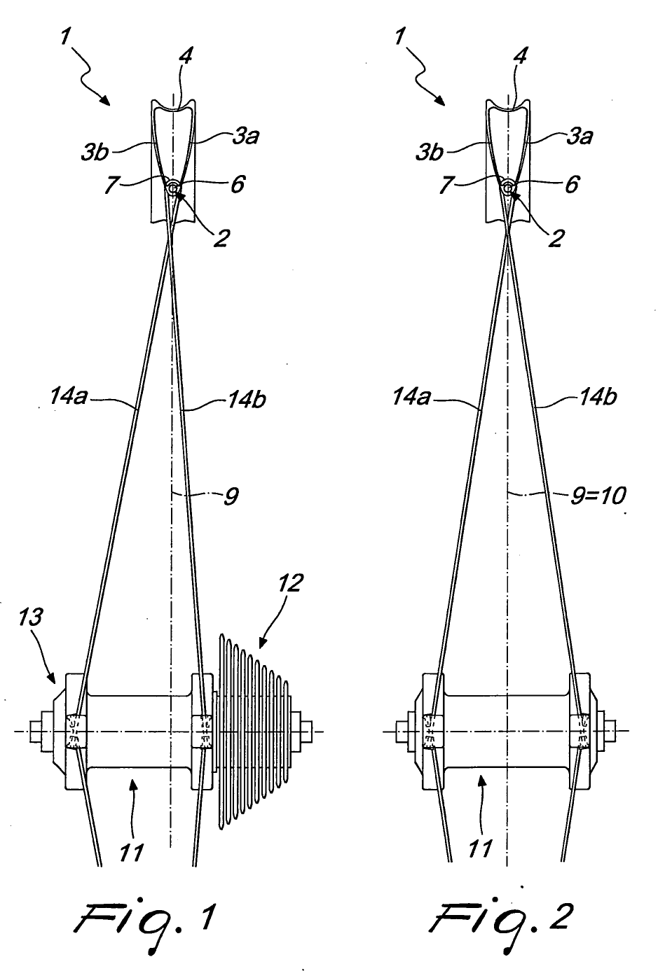

The arms 14a, 14b can be arranged symmetrically or not with respect to the midplane 9 of the base 4, as shown in FIGS. 1 and 2, or can be symmetrical with respect to the plane 10 that passes through the vertex 2 and through the central region of the hub 11, as shown in FIG. 8.

The arrangement of the arms 14a, 14b is such that they lie at mutually parallel planes, as shown in FIGS. 13, 14 and 15, such planes not coinciding with the plane of arrangement of the end 7.

Another particularity of the wheel is that on the wheel 1 there are, on the sides 3a, 3b and in a region which is adjacent, and therefore very close, to the insert or guide 6, a plurality of pairs of holes 15a, 15b, in which it is possible to insert the spoke 8.

As shown in FIGS. 13, 14 and 15, each one of the pairs of holes 15a, 15b can be provided along an axis which is more or less inclined with respect to the axis of arrangement of the insert or guide 6 or along an axis which is perpendicular thereto, as shown in FIG. 14.

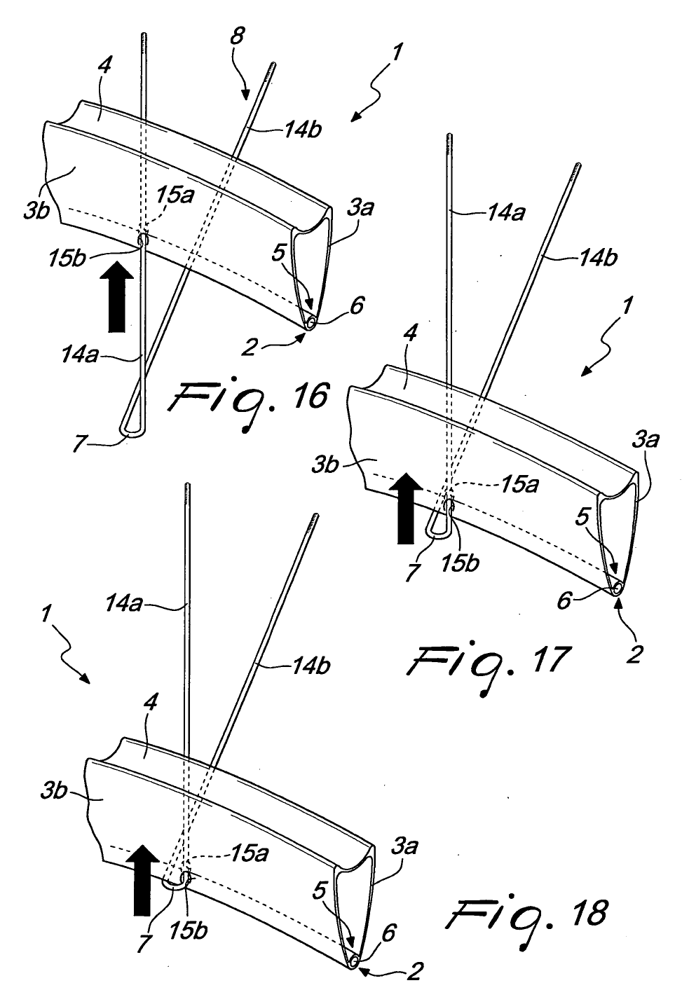

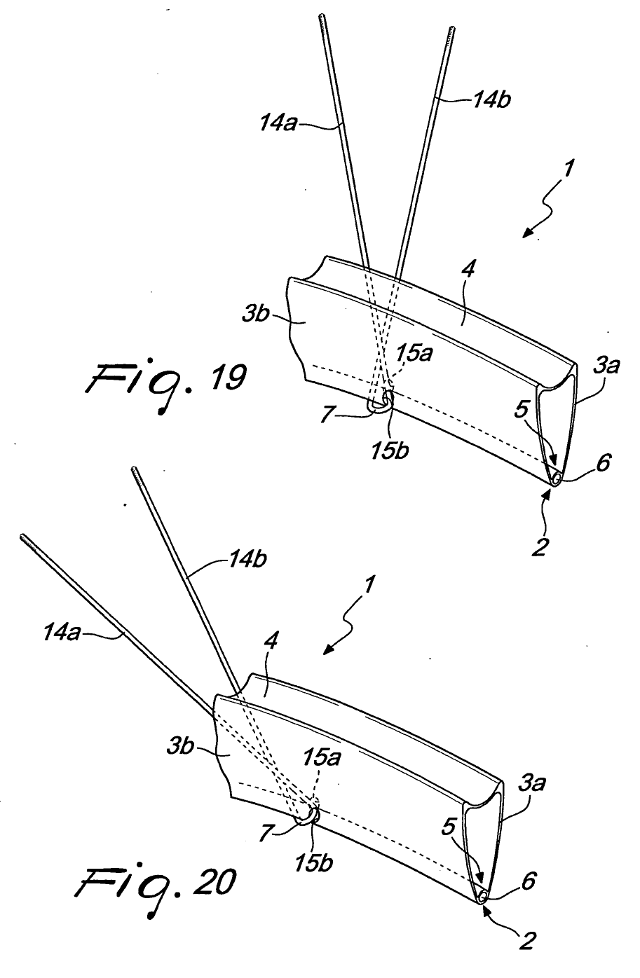

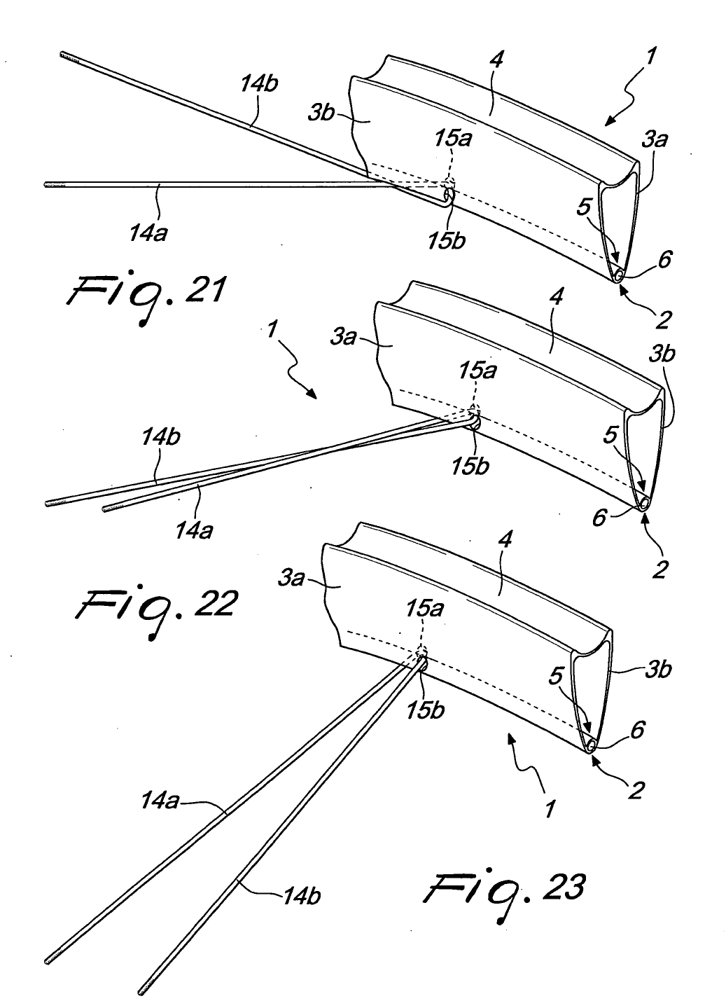

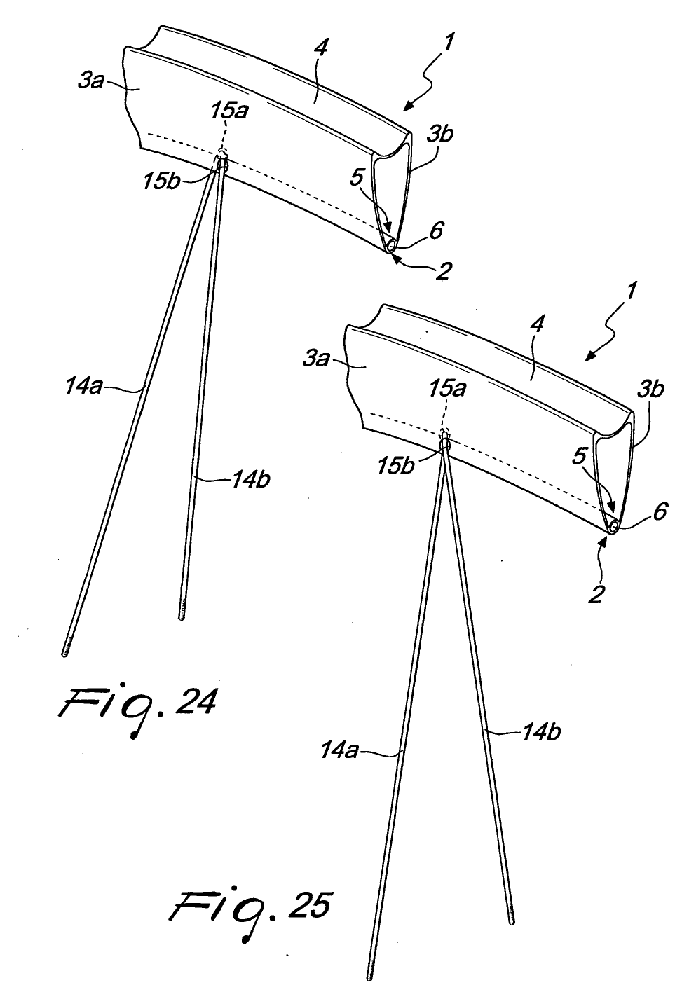

FIGS. 16 to 25 illustrate the method for quick and easy coupling of each spoke 8 to the provided pair of holes 15a, 15b of the rim 1: it is in fact sufficient to insert for example the tip, which is conveniently threaded, for example of the arm 14a at the hole 15b and at the hole 15a and then move closer to the vertex 2 the end 7 and impose on the spoke 8 a rotation which arranges it approximately at right angles to the rim 1.

The interconnection of the threaded ends of the arms 14a, 14b with the hub occurs by means of a known method.

In practice it has been found that the wheel, particularly for cycles or motorcycles, according to the present invention, has fully achieved the intended aim and objects, since the spoke can be formed as rigid but with controlled detensioning, i.e. the arms 14a, 14b behave like a rigid triangular structure, in which the third side is constituted by the hub 11, when they are tensioned, also thanks to the strain-hardening of the metal of the spoke in the arc-like region of the insert or guide 6 and of the friction of its end 7 caused by its tension.

In case of breakage, however, the spoke 8 detensions along its entire length and therefore both at the arm 14a and at the arm 14b, by way of the possible slight sliding of the arc-like end 7 of the spoke 8 at the insert or guide 6.

This prevents the occurrence of lateral wobbling, which is typical in the background art, of the wheel, allowing instead the cyclist to continue with sports activity.

If the spoke is made of composite material, the rigidity is due to the preforming of the molding process, which hardens the resin component of the composite.

The particular configuration of the spoke 8, of the open-loop type and provided with an arc-like end 7, allows to insert the spoke rapidly and easily at the rim without therefore imposing thereon inelastic deformations and therefore extending its life cycle.

The spoke, in its coupling to the rim, does not load its sides 3a, 3b, since the spoke 8 does not engage rigidly the rim 1.

Moreover, the presence of the insert or guide 6 on which the end 7 of the spoke 8 rests and slides allows to distribute traction in a balanced manner on a large part of the internal region of the rim 1, and this extends the life cycle of the rim or can allow to provide a lighter rim for an equal life cycle.

The spoke thus provided further does not have “tight” bends which might weaken it, and in this case also, therefore, there is a further characteristic that extends its life cycle or allows to provide it in a lighter form for an equal life cycle.

As hypothesized, in the interconnection between the spoke 8 and the rim 1 any possible interference with the brake pad is eliminated thanks to the interconnection obtained in practice at the vertex 2 of the rim 1 or due to the distance of the slider from the working plane.

The wheel allows not only to continue racing in case of breakage of a spoke but also to have no vibration effect when loaded due to dynamic detensioning of the spokes.

Moreover, there is optimum transmission of the torque of the hub to the rim, this transmission being balanced on the right and left sides of the rim and thus eliminating any possible dynamic lateral deformation thanks to the provision of a single spoke that rests and slides at the insert or guide 6.

The wheel thus obtained is easy to assemble, and the spoke is easy and quick to replace, without even requiring to remove the tire.

In view of the shape of the rim and of the spoke it is possible to use a tubeless rim and to provide a wheel that is compatible with tubeless tires thanks to the lateral insertion of the spokes, which does not force to provide holes in the upper part or base 4 of the rim 1.

If an asymmetric rim is used, the result in terms of camber on the freewheel side or on the disc brake side is maximum, and so is the displacement to the left of the left flange while maintaining the left side-right side tensions identical or similar; this allows to provide a wheel whose characteristics of lateral and torsional rigidity are extremely high, while maintaining a low weight and a modest cost.

Of course, the wheel can be of any type, such as for example a racing wheel or an MTB or cruiser wheel.

The wheel particularly for cycles is susceptible of numerous modifications and variations, all of which are within the scope of the appended claims.

All the details may further be replaced with other technically equivalent elements.

In practice, the materials employed, so long as they are compatible with the specific use, as well as the contingent shapes and dimensions, may be any according to requirements and to the state of the art.

Thus, for example, the sectional shape of the rim 1 can also be square or rectangular or U-shaped or pentagonal, as shown in FIGS. 26 to 32.

Moreover, the spoke 8 can be constituted for example by a single spoke formed by a single long cord, for example made of composite material, for example made of the material known by the trademark Kevlar or other fibers, such as aramid or carbon fibers; such single cord is inserted in each instance in the pair of holes 15a, 15b to be then guided and/or locked stably or temporarily on appropriately provided means formed on the hub and then reinserted in another pair of holes 15a, 15b, et cetera.

Quick and easy balancing is thus obtained by way of the sliding on the insert or guide 6; in this case, by using a nonrigid spoke, and therefore a cord for example made of the material known by the trademark Kevlar or other fibers, it is preferable to reduce the ability of such cord to slide at the insert or guide 6, for example by using surfaces with a high degree of roughness or technically equivalent solutions.

The disclosures in Italian Patent Application No. TV2008A000147 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A wheel, particularly for cycles or motorcycles, comprising a rim which has, in transverse cross-section, a polygonal shape, further comprising, at an internal region, an insert or guide which is arc-like, for the resting and sliding of a complementarily shaped end of a spoke which is shaped like an open loop and can be inserted at openings formed in said rim in a region that is adjacent to said arc-like guide or insert.

12. The wheel according to claim 11, comprising a rim which has, in a transverse cross-section, a V-shaped configuration which has a vertex which is rounded and is blended at sides to a base for supporting a tire or inner tube, wherein at the internal region of said vertex there is, inside said rim, said insert or guide which has, in the direction of said overlying base, an arc-like shape for the resting and sliding of the complementary shaped end of the spoke, said insert or guide being constituted by an element which is applied or obtained during the provision of said rim.

13. The wheel according to claim 11, wherein the transverse sectional shape of said rim is of a mirror symmetrical type with respect to a midplane of the base or of an asymmetric type, in which said insert or guide lies on a plane which is parallel and therefore spaced with respect to said midplane of said base.

14. The wheel according to claim 11, wherein each spoke is constituted by a single wire that is bent approximately halfway along its length so as to form said arc-like end which is shaped so that it can rest and slide at said insert or guide that is present within said rim.

15. The wheel according to claim 11, wherein said spoke has two arms, which are mutually crossed or are substantially parallel to each other.

16. The wheel according to claim 15, wherein said arms are arranged symmetrically with respect to said midplane or with respect to said plane, the arrangement of said arms being such that they lie at mutually parallel planes which however do not coincide with the plane of arrangement of said end.

17. The wheel according to claim 12, wherein on said rim there is, on said sides and/or so as to affect the surface that lies opposite said base and in a region which is adjacent, and therefore very proximate, to said insert or guide, a plurality of pairs of holes, within which said spoke can be inserted.

18. The wheel according to claim 17, wherein each one of said pairs of holes is provided along an axis which is more or less inclined with respect to the axis of arrangement of said insert or guide or along an axis which is perpendicular to the latter.

19. A wheel particularly for cycles, comprising a rim which has a polygonal shape in transverse cross-section, characterized in that it has, at the internal region, an arc-like insert or guide for the resting and sliding of a complementarily shaped end of a spoke constituted by a single long cord, made of composite material, which can be inserted at openings formed in said rim in a region that is adjacent to said arc-like insert or guide and is guided on said hub.

20. The wheel according to claim 19, wherein said cord is made of a material known by the trademark Kevlar or of other fibers, such as aramid or carbon fibers, said insert or guide having a surface with a high degree of roughness in order to reduce the ability of said single cord to slide.
